(19) United States
(12) Patent Application Publication
(10) Pub. No.: US 2003/0012224 A1
(43) Pub. Date: Jan. 16, 2003

(54) Band control device and method for multiplexing and outputting packets

(76) Inventors: Toyoki Kawahara, Kanagawa (JP); Tomohiro Uchida, Kanagawa (JP); Atsushi Nakamura, Kanagawa (JP); Kazuhiro Shinsako, Kanagawa (JP); Yuji Hashimoto, Kanagawa (JP)

Correspondence Address: RATNERPRESTIA, P O BOX 980, VALLEY FORGE, PA, 19482-0980, US

(21) Appl. No.: 10/188,949

(22) Filed: Jul. 3, 2002

(30) Foreign Application Priority Data
Jul. 10, 2001 (JP) 2001-208826

(51) Int. Cl. H04J 3/16

(52) U.S. Cl. 370/468

(57) ABSTRACT

A master communication apparatus uses a band control device comprising a band weight holding section storing weight proportional to minimum assured speed based on a slave communication apparatus, an assignment number-of-times counter for counting, based on a constant packet size, a length of a packet transmitted by the slave communication apparatus, a transmission sequence control section for giving transmission permissions in a sequence, based on a constant packet size, to the slave communication apparatuses and suspending the transmission permission in a sequence that the assignment number-of-times counter exceeds a band weight amount corresponding to the slave apparatus, thereby assuring a minimum speed based on the slave communication apparatus and reducing the variation in data transmission wait time.

### FIELD OF THE INVENTION

This invention relates to a band control device and method provided in a master communication apparatus for giving minimum band assurances to a plurality of slave communication apparatuses, in a one-to-multiplicity communication system connected oppositely with one master communication apparatus and a plurality of slave communication apparatuses by a branched transmission line so that the slave communication apparatuses can communicate through a shared transmission band.

### BACKGROUND OF THE INVENTION

Conventionally, such band control devices have been described, e.g. in European Patent Publication No. 0952693. FIG. 8 shows a related art band control device described in the publication.,

In FIG. 8, buffer memories 805-808 are to temporarily store the packets inputted at input ports 801-804. A transmission circuit 810, on an output-port side, extracts packets out of the buffer memories 805-808 in a predetermined sequence, and outputs them onto an output port 809.

Meanwhile, a packet extraction sequence setting section 811 has a request confirmation counter 812, a sequence rearrangement counter 813 and a sequence calculation section 814. The request confirmation counter 812 is to indicate a sequence of checking the input ports 801-804. The sequence rearrangement counter 813 is to change the sequence of extraction. Meanwhile, the sequence calculation section 814 uses the request confirmation counter 812 and sequence rearrangement counter 813 to change the sequence of packet extraction out of the buffer memories 805-808 each time a round of packet extraction is completed, so that the packet extraction out of the input ports 801-804 can be controlled to an equal frequency at between the input ports 801-804.

FIG. 9 shows a transition of a sequence that the sequence calculation section 814 extracts packets by the use of the request confirmation counter 812 and the sequence rearrangement counter 813. Whenever the request confirmation counter 812 completes one round, the sequence rearrangement counter 813 counts up one by one. The sequence of buffer memories 805-808, from which the sequence calculation section 814 extracts packets, is calculated by an exclusive OR of the request confirmation counter 812 and sequence rearrangement counter 813.

Namely, in FIG. 9, in the case of the sequence rearrangement counter 813 has “0” (901), each time the request confirmation counter 812 counts up by one from “0”, the packet extraction out of buffer memories 805-808 changes to a sequence of #0 buffer memory 805, #1 buffer memory 806, #2 buffer memory 807 and #3 buffer memory 808. Then, the request confirmation counter 812 completes one round, and the sequence rearrangement counter 813 counts up by one to “1” (902). Thereupon, the packet extraction out of buffer memories transits to a sequence of #1 buffer memory 806, #0 buffer memory 805, #3 buffer memory 808 and #2 buffer memory 807. Similarly, in the case of counting up to 2 in the sequence rearrangement counter 813 (903), the packet extraction out of buffer memories is in a sequence of #2 buffer memory 807, #3 buffer memory 808, #0 buffer memory 805 and #1 buffer memory 806. When the sequence rearrangement counter 813 counts up to 3 (904), the sequence is #3 buffer memory 808, #2 buffer memory 8017, #1 buffer memory 806 and #0 buffer memory 805.

This method equalizes the mean wait time of a packet arrival at the input port 801-804 to an extraction therefrom, at between the input ports 801-804.

FIG. 7 shows a system configuration that the related art band control device is utilized in a one-to-multiplicity communication system.

Herein, a station-end communication apparatus 7000 is connected to subscriber-end communication apparatuses 7101-7103 by using optical cables 7201-7204 through a star coupler 7205.

The subscriber-end communication apparatus 7101-7103 is configured with a subscriber-end terminal unit 7111-7113 for termination of signals and light communicated between the subscriber-end communication apparatus 7101-7103 and the station-end communication apparatus 1000, a line interface 7121-7123, and a LAN interface 7131-7133. The line interface 7121-7123 is connected with a telephone 7141-7143. The LAN interface 7131-7133 is connected with a computer or line concentrator (HUB) 7151-7153.

Meanwhile, the station-end communication apparatus 7000 is configured with a station-end terminal unit 7001 for termination of signals and light communicated between the station-end communication apparatus 7000 and the subscriber-end communication apparatus 7101-7103, a cross-connect 7002 for separation and multiplexing of the signals communicated with the subscriber-end communication apparatus 7101-7103 (hereinafter, described XC), a line interface 7003 and a LAN interface 7004. The station-end terminal unit 7001 is provided with a not-shown packet-extraction sequence setting section 811 utilizing the related-art band control device, and has a request confirmation counter 812, a sequence rearrangement counter 813 and a sequence calculation section 814. The line interface 7003 is connected with an exchange 7005 while the LAN interface 7004 is with a router 7006.

In the case there exists the data to be sent from the subscriber-end communication apparatus 7101-7103 to the station-end communication apparatus 7000, a transmission request is sent to the station-end communication apparatus 7000. The data is sent to a shared band according to a transmission permission from the station-end communication apparatus 7000.

FIGS. 10A and 10B are explanatory views showing one example of data transmission and reception between the station-end communication apparatus 7000 and the subscriber-end communication apparatuses 7101-7103 in the communication system shown in FIG. 7.

In packet communication, there is a less frequency for all the subscribers to simultaneously use the band and further the packets to be transferred are variable in length. Accordingly, as shown in FIGS. 10A and 10B, a shared band is set up on a transmission path so that each subscriber-end communication apparatus can use the shared band where necessary.

As shown in FIG. 10A, the subscriber-end communication apparatus 7101-7103 calculates the number of times of transmission Rn#i (hereinafter, described transmission number of times) of data (size: Sp#i) from the subscriber-end communication apparatus through an upward shared band 104 (size: Ss) with a period Tx. The transmission number of times Rn#i and transmission request flag is sent, using an upward control signal 101-103 defined based on each subscriber-end communication apparatus, to the station-end communication apparatus 7000. Incidentally, the transmission number of times Rn#1 is calculated in Equation (1). The transmission request flag, in data transmission, is set at “1” (ON-state).

Rn#i=Ss/Sp#1 (1)

The station-end communication apparatus 1000 selects one subscriber-end communication apparatus by the packet-extraction sequence setting section 811 of within the station-end terminal unit. As shown in FIG. 10B, transmitted is a unique number (#0-#N) of a transmission-permitted subscriber-end communication apparatus, set on a downward control signal 105, to an extent of within a maximum packet length the station-end communication apparatus 7000 can use a data transmission amount in packet communication. The subscriber-end communication apparatus 7101-7103 receives the transmission permission flag. In the case that it is an own unique number, an upward packet is transmitted.

In the packet-extraction sequence setting section 811, as explained using FIG. 9, whenever the request confirmation counter 812 completes one round of process, the sequence rearrangement counter 813 is counted up by one so that the sequence calculation section 814 can calculate an exclusive OR of the two counters. The calculated value is sent as a unique number to a subscriber-end communication apparatus to which a transmission permission is to be given.

Namely, where connecting four subscriber-end communication apparatuses having unique numbers #0-#3, when the sequence rearrangement counter has “0” (901), transmission permissions are provided in a sequence of subscriber-end communication apparatus #0, subscriber-end communication apparatus #1, subscriber-end communication apparatus #2 and subscriber-end communication apparatus #3. When the sequence rearrangement counter then counts up by one (902), transmission permissions are provided in a sequence of subscriber-end communication apparatus #1, subscriber-end communication apparatus #0, subscriber-end communication apparatus #3 and subscriber-end communication apparatus #2. Subsequently, due to counting up in the sequence rearrangement counter, transmission permissions with a changed sequence are similarly provided to the subscriber-end communication apparatuses. This equalizes the mean time of sequence wait time (hereinafter, described as data transmission wait time) at between the subscriber-end communication apparatuses.

Herein, the setting of a band amount minimally assured by the related art station-end communication apparatus 7000 (hereinafter, described as minimum assured speed) differently to the subscriber-end communication apparatus 7101-7103 can be realized by changing a packet length to be transferred at once proportionally to the minimum assured speed.

For example, provided that a maximum band usable over the entire system is Bmax, a minimum assured speed Bi is set onto the subscriber-end communication apparatuses in the number of N (N: integer greater than 2) (unique number i of a subscriber-end communication apparatus=1-N). However, accommodation restriction is carried out not to make the sum of Bi in excess of Bmax. Furthermore, a maximum packet length to be sent at once is given as Wi×MTU. Herein, Wi is a weight of each subscriber-end communication apparatus calculated by Bi/Bmax (hereinafter, described as band weight) and MTU is a maximum packet length size in packet communication. In the case that the product between a band-weight sum Wsum and a required time Tu for transmitting a packet having a maximum packet length size corresponds to one period of a minimum assured speed on the one-to-multiplicity communication system, a minimum assured speed Bi can be assured to any of the subscriber-end communication apparatuses even in such a congestion state that the subscriber-end communication apparatuses issue transmission requests at all times. However, with the related art structure, where minimum assured speed are set differently to the subscriber-end communication apparatuses 7101-7104, there is a possible increase of variation value in the data transmission wait time.

This will be explained using FIG. 11.

FIG. 11 shows a packet transmission arrangement in that case. Namely, although transmission is carried out in a manner the packet transmission sequence is equalized, within one period (Wsum×Tu) (shown at 112 in the figure), packets are transmitted successively in an amount of a band weight set on each subscriber-end communication apparatus.

Herein, the data transmission wait time of from transmitting a packet at the subscriber-end communication apparatus #1 to the next transmission of a packet at the subscriber-end communication apparatus #1 is maximally Tu×(Wsum−W₁)×2 (shown at 111 in the figure) and minimally Tu×W (W:0 or a positive integer). Namely, the data transmission wait time has the following variation value.

Tu×(Wsum−W₁)×2−Tu×W=Tu×(2Wsum−2W₁−W)

Namely, a maximum is attained in the case of Wi of “1”.

In this manner, where there is a great variation value in data transmission wait time, when voices or images are real-time communicated on the subscriber-end communication apparatus, the packet received cannot be followed up by its processing. This results in a problem of voice disconnection, partly missing an image or the like. As a countermeasure, there is a method of providing a buffer memory for process time adjustment to absorb the variation. This, however, requires a appropriate buffer memory taking such variation into account.

The present invention is to solve such a problem as in the related art. It is an object to provide a band control device and method provided in a station-end communication apparatus which can reduce the variation value in data transmission wait time on each of subscriber-end communication apparatuses set with an arbitrary value of minimum assured band based on the subscriber-end communication apparatus.

### SUMMARY OF THE INVENTION

A band control device of the present invention, for solving the foregoing problem, comprises: a band weight holding section storing weights proportional to minimum assured speed set on communication apparatuses at the other ends of communication; an assignment number-of-times counter for counting, based on a predetermined packet size, a packet transmitted by the communication apparatus; a transmission sequence control section for giving, based on the packet size, transmission permissions sequentially to the communication apparatuses, and suspending the transmission permission when a count value of the assignment number-of-times counter exceeds the band weight corresponding to the communication apparatus.

In the band control device of the invention, the transmission sequence control section further changes the sequence when all of the count values exceed the band weights.

Meanwhile, a band control method of the invention comprises: a step of counting, based on a predetermined packet size, packets transmitted by communication apparatuses at the other ends of communication; a step of, giving transmission permissions, based on the packet size, repeatedly in a same sequence to the communication apparatuses until a count value of the counting exceeds a band weight; a step of suspending the transmission permission when the count value exceeds a band weight corresponding to the communication apparatus; and a step of changing a sequence of giving transmission permissions when the count value exceeds the band weights on all of the communication apparatuses.

In a band control method of the invention, the change of a sequence is a process to equalize a sequence of transmission permissions to be given to the communication apparatuses.

### BRIEF DESCRIPTION OF THE DRAWINGS

FIG. 1 shows a block configuration diagram of a one-to-multiplicity communication system in an embodiment of the present invention;

FIG. 2 shows a block configuration diagram of a packet communication processing section of a subscriber-end communication apparatus of the one-to-multiplicity communication system in the embodiment of the invention;

FIG. 3 is a block configuration diagram of a station-end terminal unit having a band control device in the embodiment of the invention;

FIG. 4 shows a band allocation process flow chart of the band control device in the embodiment of the invention;

FIG. 5 shows a transition figure of an assignment number-of-times counter of the band control device in the embodiment of the invention;

FIG. 6A shows a packet transmission arrangement diagram by a band control device in a related art;

FIG. 6B shows a packet transmission arrangement diagram by the band control device in the embodiment of the invention;

FIG. 7 shows a block configuration diagram of a one-to-multiplicity communication system in a related art;

FIG. 8 is a block configuration diagram of a band control device in the related art;

FIG. 9 shows a transition figure with a designation sequence by a subscriber-end communication apparatus in the embodiment of the invention and related art;

FIG. 10A shows a diagram of upward data transmission/reception between the station-end and subscriber-end communication apparatuses of the one-to-multiplicity communication system in the embodiment of the invention and related art;

FIG. 10B shows a diagram of downward data transmission/reception between the station-end and subscriber-end communication apparatuses of the one-to-multiplicity communication system in the embodiment of the invention and related art; and

FIG. 11 shows a packet transmission arrangement diagram by the band control device in the related art.

### DETAILED DESCRIPTION OF THE PREFERRED EMBODIMENTS

The embodiment of the present invention will be explained below, using the drawings.

Embodiment

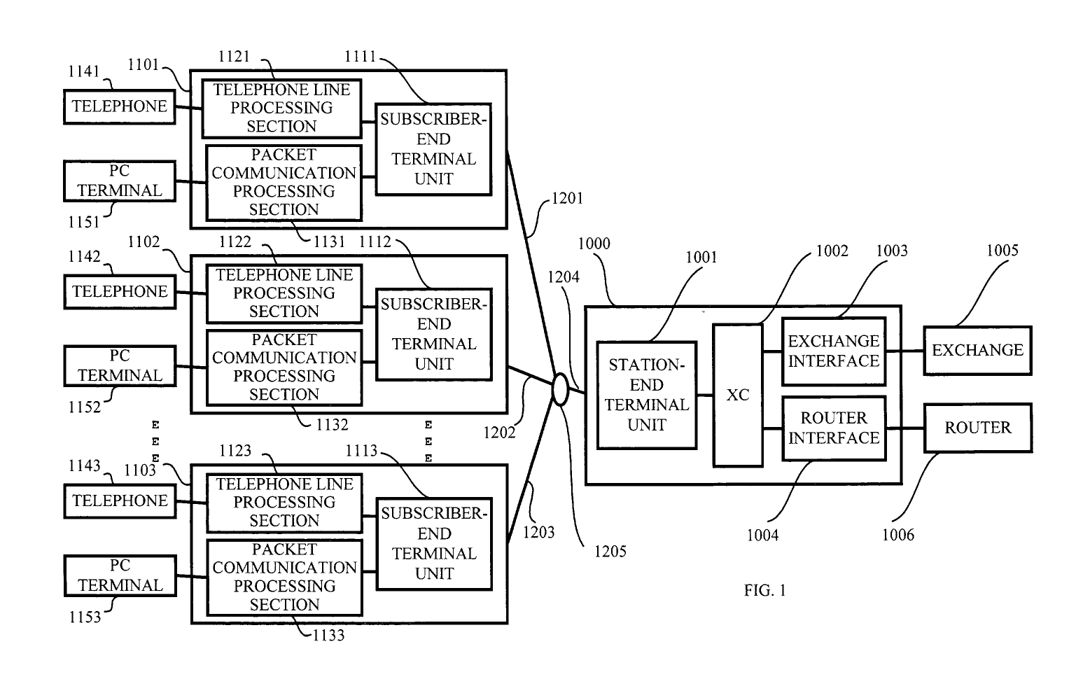

FIG. 1 shows a block configuration diagram of a one-to-multiplicity communication system in an embodiment of the invention.

In FIG. 1, connection is made between one station-end communication apparatus 1000, or a master communication apparatus, and a plurality of subscriber-end communication apparatuses 1101-1103, or slave apparatuses, in a point-to-multipoint form. Namely, an optical fiber 1204 is connected to the station-end communication apparatus 1000 while optical fibers 1201-1203 are connected to the subscriber-end communication apparatuses 1101-1103. The optical fiber 1204 and the optical fibers 1201-1203 are connected together by an optical coupler 1205 to couple or branch transmission signals.

Each subscriber-end communication apparatus 1101-1103 is configured by a subscriber-end terminal unit 1111-1113, a telephone line processing section 1121-1123 and a packet communication processing section 1131-1133.

The subscriber-end terminal unit 1111-1113 cooperates with the station-end communication apparatus 1000 to carry out termination of control signals and light as well as separation and multiplexing of telephone and Ethernet information data.

The telephone line processing section 1121-1123 is a telephone line interface connected with an analog telephone 1141-1143.

The packet communication processing section 1131-1133 is connected with a PC terminal unit 1151-1153. This sends a transmission request to the station-end communication apparatus 1000 when there is the data to be sent therefrom to the station-end communication apparatus 1000. According to the transmission permission from the station-end communication apparatus 1000, the data can be sent to a shared band.

The station-end communication apparatus 1000 is configured with a station-end terminal unit 1001, an XC 1002 as a fixed switch, an exchange interface 1003 and a router interface 1004.

The station-end terminal unit 1001 performs separation and multiplexing on the communication data of a subscriber from the subscriber-end communication apparatus 1101-1103.

The XC 1002 performs separation and multiplexing on the telephone data and packet contained in information data. This is a fixed switch arranged between an exchange interface 1003 to an exchange 1005, a router interface 1004 to a router 1006, and the station-end terminal unit 1001.

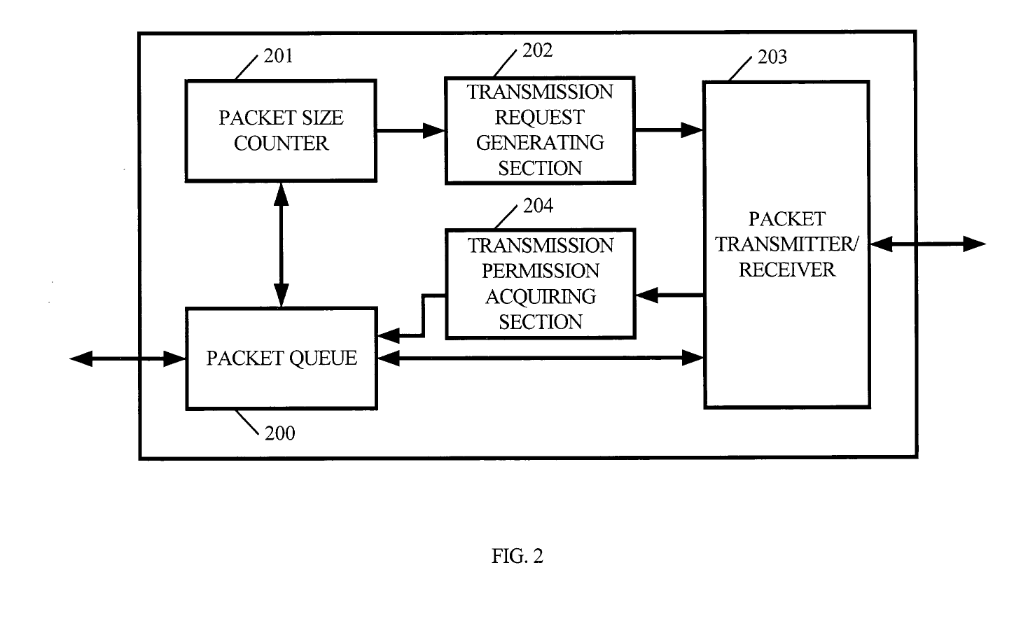

FIG. 2 is a block configuration diagram explaining a packet transfer process of within the packet communication processing section 1131-1133.

A packet queue 200 is to,temporarily hold an Ethernet packet of from a personal computer or the like. A packet size counter 201 is to count the number of times of transmissions Rn.

A transmission request generating section 202 is to map the number of times of transmission Rn and transmission request onto an upward control signal. A packet transmitter/receiver 203 is to transmit and receive a control signal and packet data to and from the subscriber-end terminal unit 1111-1113.

A transmission permission acquiring section 204 receives a transmission permission from the station-end terminal unit 1001, to issue an instruction for queuing to the packet queue 200.

The packet communication processing section 1131-1133 thus configured extracts a packet size held within the packet queue 200 and calculates the transmission number of times Rn by use of the packet size counter 201. In the transmission request generating section 202, an upward control signal mapped with a transmission request is generated, and transmitted at the packet transmitting/receiving section 203.

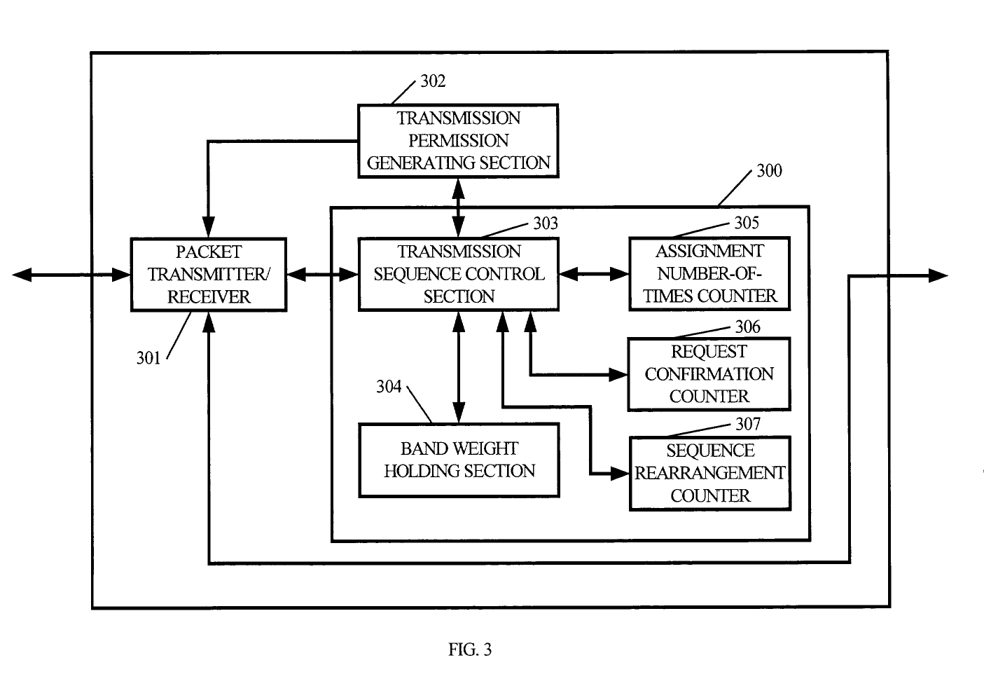

Meanwhile, FIG. 3 is a block configuration diagram of a station-end terminal unit 1001 provided in the station-end communication apparatus 1000.

A packet transmitter/receiver 301 transmits and receives a control signal and packet data to and from the subscriber-end communication apparatus 1101-1103. A transmission permission generating section 302 carries out mapping of a transmission permission to the subscriber-end communication apparatus 1101-1103 on a downward control signal.

A band control unit 300 is to monitor the packets received by the packet transmitter/receiver and, next, control a sequence of sending packet transmission permissions to the subscriber-end communication apparatuses 1101-1103. This is configured with a-transmission sequence control section 303, a band weight holding section 304, an assignment number-of-times counter 305, a request confirmation counter 306 and a sequence rearrangement counter 307.

The transmission sequence control section 303 selects a subscriber-end communication apparatus 1101-1103 to which a transmission permission is provided.

The band weight holding section 304, to system startup, holds a band weight Wi determined by dividing a minimum assured speed Bi assigned based on the subscriber-end terminal unit 1101-1103 by a minimum unit b. Although fine band assurance is available by further reducing 6, this increases the sum Wsum of band weights to increase the sum of transmission wait time. Accordingly, there is a need to set with a proper value.

There are the assignment number-of-times counters 305 in the number of the subscriber-end communication apparatuses 1101-1103. This counts the assignment number of times based on a maximum packet length, for each subscriber-end communication apparatus 1101-1103. The assignment number-of-times counter 305 is set with a count value CWi assigned based on the subscriber-end terminal unit as an initial value.

Meanwhile, the request confirmation counter 306 and sequence rearrangement counter 307 operate similarly to that of the related art.

The station-end terminal unit 1001 thus configured assigns a band to each slave subscriber-end terminal unit 1111-1113 to guarantee a minimum assured speed Bi by use of a band assignment process explained in the below. Next, the operation will be explained.

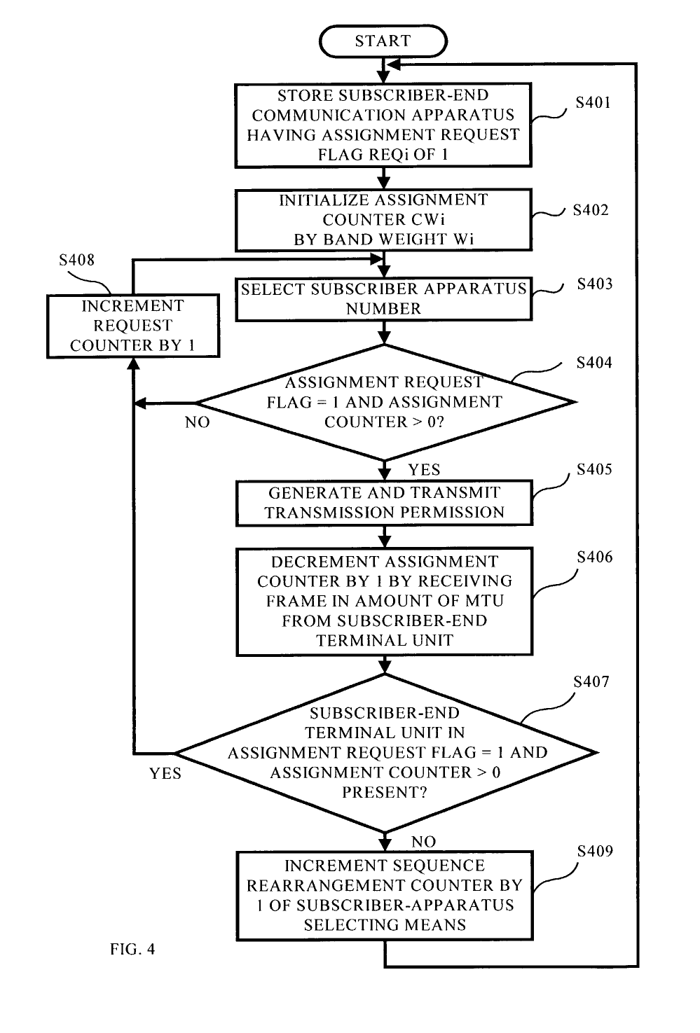

FIG. 4 is a flowchart showing an operation of band assignment process by the station-end terminal unit 1001 of this embodiment.

At first, receiving an upward control signal from the subscriber-end communication apparatus 1101-1103, the packet transmitter/receiver 301 notifies a unique number having a transmission request flag REQi of 1 to the transmission sequence control section 303. The transmission sequence control section 303, in turn, stores the unique number of the subscriber-end communication apparatus 1101-1103 (step S401).

In this timing, a count value CWi of the assignment number-of-times counter 305 is initialized onto the band weight Wi based on the subscriber-end communication apparatus 1101-1103 (step S402).

Then, the transmission sequence control section 303 calculates an exclusive OR of the request confirmation counter 306 and sequence rearrangement counter 307, similarly to that of the conventional band control unit described in the foregoing publication (step S403). The result is calculated as a unique number to a subscriber-end communication apparatus 1101-1103 to which a transmission permission is to be provided.

It is then confirmed whether the transmission request flag REQi of the subscriber-end communication apparatus 1101-1103 corresponding to the unique number and the count value CWi of the assignment number-of-times counter 305 agree with the following Conditional Equation (2) or not (step S404).

(REQi=1) AND (CWi>0) (2)

When Equation (2) is satisfied, the unique number to the subscriber-end communication apparatus 1101-1103 is mapped on a downward control signal by the transmission permission generating section 302. Thus, a transmission permission is transmitted and notified to the relevant subscriber-end communication apparatus 1101-1103 (step S405). When Equation (2) is not satisfied, the request confirmation counter 306 is incremented by “1” (step S408), and the process returns to step S403.

Then, the transmission sequence control section 303, previously monitors a size of a transmission packet from the subscriber-end terminal unit, based on a shared band Ss size. This, when receiving a frame having a maximum packet length (MTU), reduces by “1” the count value CWi of the assignment number-of-times counter 305 pursuant to the transmitting subscriber-end communication apparatus 1101-1103 (step S406).

Next, it is confirmed whether there is a subscriber-end terminal unit in agreement with Equation (2) (step S407). In the case of an existence of even one, the request confirmation counter 306 is incremented and the process returns to step S403 (step S408).

None of the subscriber-end terminal units satisfy Equation (2), the sequence rearrangement counter 307 is incremented by “1” and the process returns to step S401 (step S409).

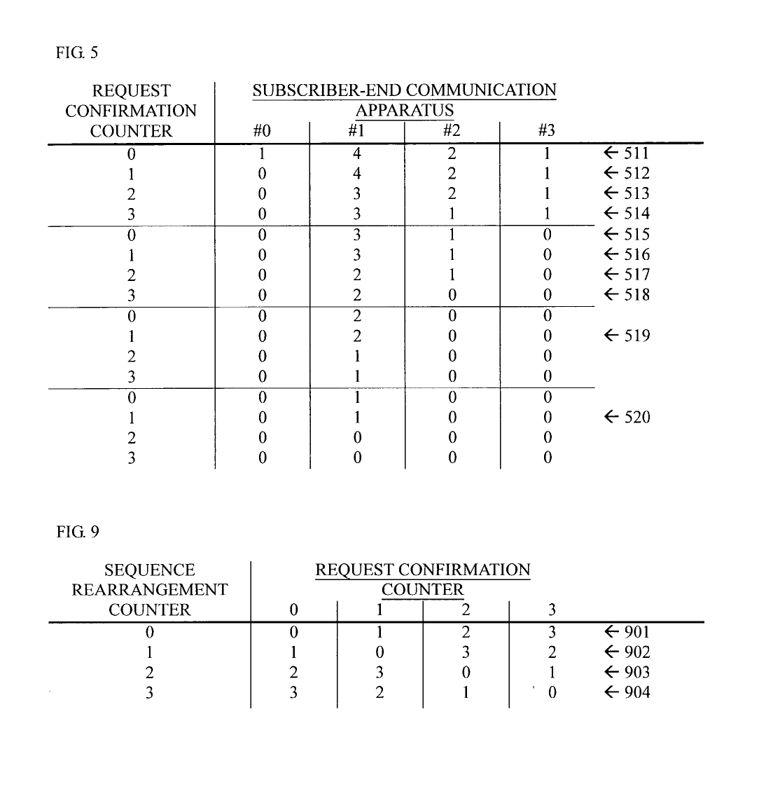

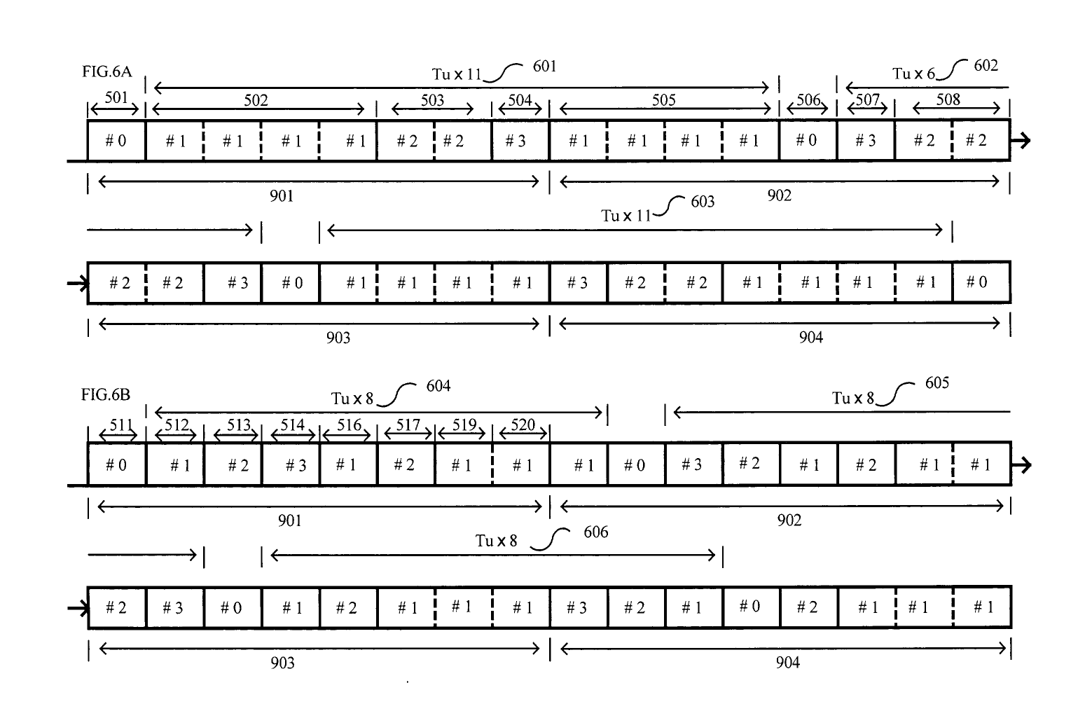

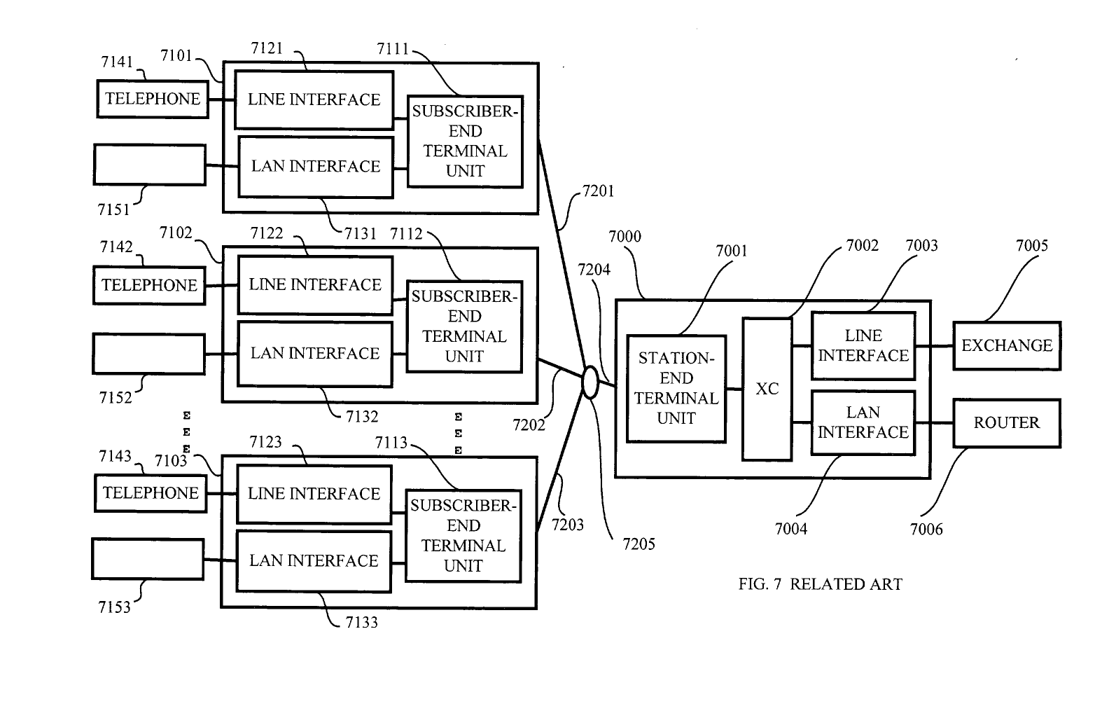

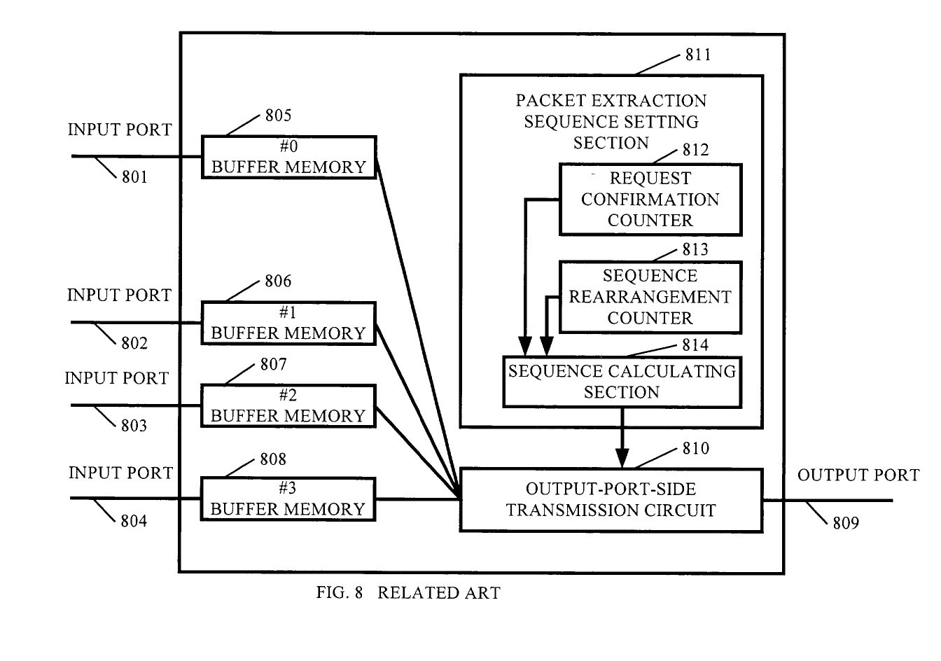

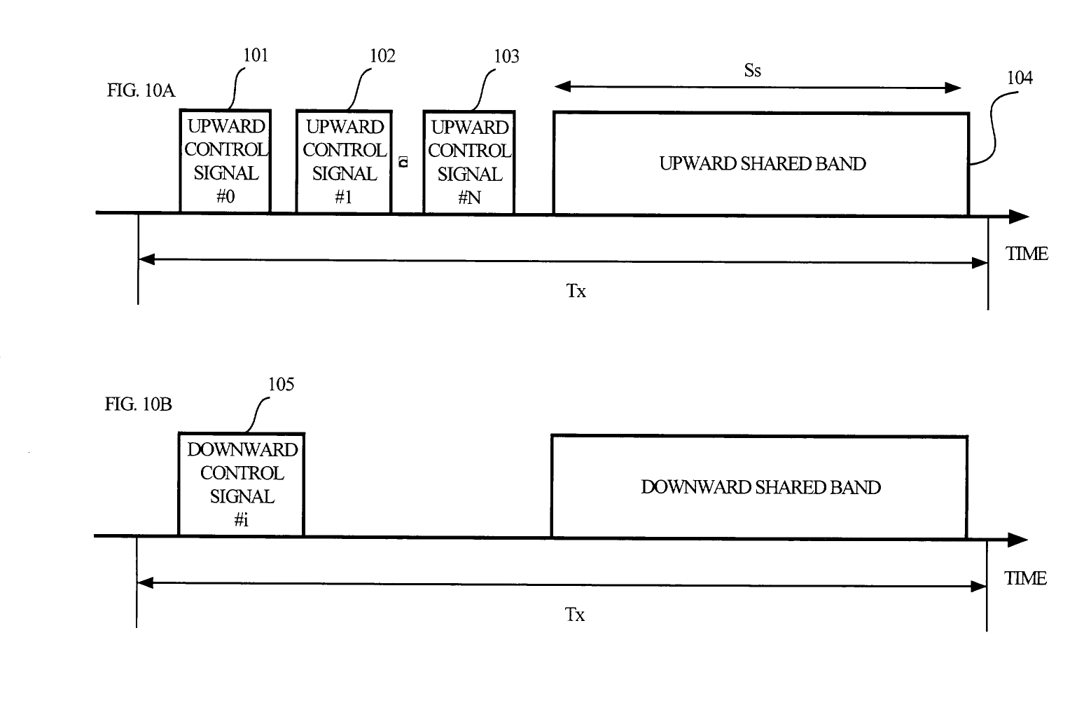

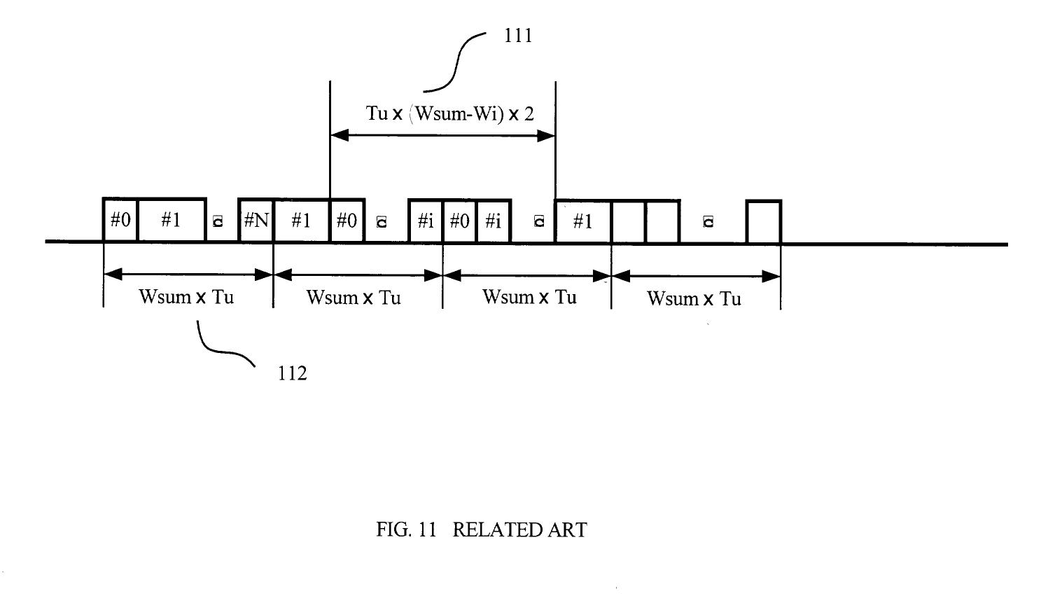

Using FIGS. 5 and 6B, explanation is made in detail on the variation value in data transmission wait time when executing the above-noted process.

This example assumes the subscriber-end communication apparatuses having unique numbers #0 to #3 wherein the respective assumably have band weights of “1”, “4”, “2” and “1”. FIG. 5 is a transition figure showing a transition of a count value CWi of an assignment number-of-times counter for each subscriber-end communication apparatus in a state that requests in a maximum packet size are issued at all times from the subscriber-end communication apparatus. FIG. 6B shows a transmission arrangement of packets in that case.

When the sequence rearrangement counter has an initial value “0”, transmission permissions are outputted, packet by packet, in a sequential order shown at 901 in the transition figure of FIG. 9 to the subscriber-end communication apparatuses #0 to #3 within one cycle of the request confirmation counter (511-514).

In the next request confirmation counter cycle, assignment request flags REQi from the subscriber-end communication apparatuses are confirmed in the same order. In this cycle, however, because the count value CW0 of the assignment number-of-times counter for the subscriber-end communication apparatus #0 is “0”, no transmission permission is sent to the subscriber-end communication apparatus #0 (515). Because the count value CW1 on the subscriber-end communication apparatus #1 is “3”, a transmission request for 1 packet is sent to the subscriber-end communication apparatus #1 (516). Because the count value CW2 on the subscriber-end communication apparatus #2 is “1”, a 1-packet transmission permission is sent to the subscriber-end communication apparatus #2 (517). Because the count value CW1 on the subscriber-end communication apparatus #3 is “0”, no transmission permission is sent (518).

This is repeated similarly until all the assignment number-of-times counters reach “0”. After ending the process, the sequence rearrangement counter counts up by 1, to carry out a process similar to the above in a sequence shown at 902 in the transition figure of FIG. 9. Because this embodiment has four subscriber-end communication apparatuses, the sequence rearrangement counter has a cycle of 901 to 903 to be repeated. FIG. 6B shows one cycle of the sequence rearrangement counter.

In FIG. 6A is shown a packet transmission arrangement in the operation using the related art station-end communication apparatus under the same condition. Namely, in a period of “0” in the first sequence rearrangement counter 813 (901), one packet is transmitted from the subscriber-end communication apparatus #0 at “0” in the request confirmation counter (501). Next, when the request confirmation counter is counted up to “1”, four packets in a band weight are successively transmitted from the subscriber-end communication apparatus #1 (502). Then, when the request confirmation counter is counted up to “2”, two packets are successively transmitted from the subscriber-end communication apparatus #2 (503). At “3” in the request confirmation counter, one packet is transmitted from the subscriber-end communication apparatus #3 (504). Completing one round in the request confirmation counter, the sequence rearrangement counter 813 counts up by “1” to transmit the packets of 505 to 508 in the next period (902). Thereafter, packets are transmitted similarly.

Herein, comparison is made, between the related art and the embodiment of the invention, on the data transmission wait time of from a packet transmission at the subscriber-end communication apparatus #0 to the subsequent packet transmission at the subscriber-end communication apparatus #0. In FIG. 6A on the related art, the wait time 601 of between the first and second assignments and the wait time 603 of between the second and third assignments are Tu×11. The wait time 602 of between the second and third assignments is Tu×6. Consequently, the data transmission wait time has a variation value Tu×5. On the other hand, the embodiment of the invention has Tu×8 in each of the wait time 604 of between the first and second assignments, the wait time 605 of between the second and third assignments and the wait time 606 of between the third and fourth assignments, as shown in FIG. 6B. This results in a wait-time variation value 0. In this manner, it can be seen that the band assignment process of the invention can greatly reduce the variation in data transmission wait time as compared to that of the related art.

As explained above, by carrying out the band assignment process as a band control method of the invention, data transmission wait time variation value can be decreased at between the subscriber-end communication apparatuses having different minimum assured speed and the station-end communication apparatus.

Meanwhile, because the packet size used in counting the number of times of assignments is based on a maximum packet length usable in packet communication, the packet received can be transmitted without division. Furthermore, it is possible to reduce the occupation time of the communication apparatus over the transmission path.

According to the invention, even where the minimum assured speed is changed based on the subscriber-end communication apparatus, it is possible to reduce the data transmission wait time variation value between the subscriber-end communication apparatus.

What is claimed:

1. A band control device comprising:
a band weight holding section storing weights proportional to minimum assured speed set on communication apparatuses at the other ends of communication;
an assignment number-of-times counter for counting, based on a predetermined packet size, a packet transmitted by said communication apparatus;
a transmission sequence control section for giving, based on the packet size, transmission permissions sequentially to the communication apparatuses, and suspending the transmission permission when a count value of the assignment number-of-times counter exceeds the band weight corresponding to the communication apparatus.

2. A band control device according to claim 1, wherein said transmission sequence control section further changes the sequence when all of the count values exceed the band weights.

3. A band control device according to claim 2, wherein, in the case that transmission permissions are given N times to said communication apparatuses in the number of N, a first to N-th one of order is assigned at least once to each of said communication apparatuses by a change of sequence.

4. A band control device according to claims 1, wherein the packet size is based on a maximum packet length available in packet communication.

5. A band control device according to claims 2, wherein the packet size is based on a maximum packet length available in packet communication.

6. A band control device according to claims 3, wherein the packet size is based on a maximum packet length available in packet communication.

7. A band control device according to claims 1, wherein the band weight is a value of the minimum assured speed on said communication apparatus divided by a predetermined minimum unit speed.

8. A band control device according to claims 2, wherein the band weight is a value of the minimum assured speed on said communication apparatus divided by a predetermined minimum unit speed.

9. A one-to-multiplicity communication system comprising:
a master communication apparatus having a band control device according to claims 1;
a plurality of communication apparatuses provided at the other ends of communication of said master communication apparatus; and
a transmission path connecting between said master communication apparatus and said plurality of communication apparatuses.

10. A one-to-multiplicity communication system comprising:
a master communication apparatus having a band control device according to claims 2;
a plurality of communication apparatuses provided at the other ends of communication of said master communication apparatus; and
a transmission path connecting between said master communication apparatus and said plurality of communication apparatuses.

11. A one-to-multiplicity communication system comprising:
a master communication apparatus having a band control device according to claims 3;
a plurality of communication apparatuses provided at the other ends of communication of said master communication apparatus; and
a transmission path connecting between said master communication apparatus and said plurality of communication apparatuses.

12. A one-to-multiplicity communication system comprising:
a master communication apparatus having a band control device according to claims 4;
a plurality of communication apparatuses provided at the other ends of communication of said master communication apparatus; and
a transmission path connecting between said master communication apparatus and said plurality of communication apparatuses.

13. A one-to-multiplicity communication system comprising:
a master communication apparatus having a band control device according to claims 5;
a plurality of communication apparatuses provided at the other ends of communication of said master communication apparatus; and
a transmission path connecting between said master communication apparatus and said plurality of communication apparatuses.

14. A one-to-multiplicity communication system comprising:
a master communication apparatus having a band control device according to claims 6;
a plurality of communication apparatuses provided at the other ends of communication of said master communication apparatus; and
a transmission path connecting between said master communication apparatus and said plurality of communication apparatuses.

15. A one-to-multiplicity communication system comprising:
a master communication apparatus having a band control device according to claims 7;
a plurality of communication apparatuses provided at the other ends of communication of said master communication apparatus; and
a transmission path connecting between said master communication apparatus and said plurality of communication apparatuses.

16. A one-to-multiplicity communication system comprising:
a master communication apparatus having a band control device according to claims 8;
a plurality of communication apparatuses provided at the other ends of communication of said master communication apparatus; and
a transmission path connecting between said master communication apparatus and said plurality of communication apparatuses.

17. A band control method comprising:
a step of counting, based on a predetermined packet size, packets transmitted by communication apparatuses at the other ends of communication;
a step of giving transmission permissions, based on the packet size, repeatedly in a same sequence to said communication apparatuses until a count value of the counting exceeds a band weight;
a step of suspending the transmission permission when the count value exceeds a band weight corresponding to said communication apparatus; and
a step of changing a sequence of giving transmission permissions when the count value exceeds the band weights on all of said communication apparatuses.

18. A band control method according to claim 17, wherein the step of changing a sequence is a process that, in the case of providing transmission permission N times respectively to the communication apparatuses in the number of N, a sequence of a first to an N-th is assigned at least once to all the communication apparatuses.
